(19) United States
(12) Patent Application Publication
(10) Pub. No.: US 2011/0117326 A1
(43) Pub. Date: May 19, 2011

(54) Three-dimensional print film structure

(76) Inventors: Sou-Kuein Chiu, Taipei (TW); I-Hui Chiu, Taipei (TW)

(21) Appl. No.: 12/591,280

(22) Filed: Nov. 16, 2009

(51) Int. Cl. B32B 3/00

(52) U.S. Cl. 428/172

(57) ABSTRACT

A three-dimensional print film structure is applicable to in-mold injection-molded decoration. The three-dimensional print film structure comprises a film, a three-dimensional printing layer, a releasing layer, a pattern layer, an impact-resistant layer and a thermal tolerance bonding adhesive. The film has a first surface and a second surface. The three-dimensional printing layer is disposed on the first surface. The releasing layer is disposed on the second surface. The pattern layer is disposed on one side of the releasing layer. The impact-resistant layer is disposed on one side of the pattern layer. The thermal tolerance bonding adhesive is disposed on one side of the impact-resistant layer. When a mold is closed, the three-dimensional printing layer can form a three-dimensional patterned decoration on a plastic material so as to provide an aesthetic effect.

### BACKGROUND OF THE INVENTION

1. Field of the Invention

s The present invention relates to a three-dimensional print film structure, and more particularly to a three- dimensional print film structure used in an in-mold injection-molded decoration technique.

2. Description of the Prior Art

Mostly, a raw material layer is used in a decorative surface of a commercially available in-mold injection -molded plastic article, and decorative patterns or words are printed on one surface of the raw material layer to form a printing layer. When plastic is used for injection molding, the printing layer is attached to the plastic material by applying an in-mold decoration technique so as to provide an aesthetic decorative effect. However, the printing layer is so hedged about with printing techniques that one side of the printing layer is only shaped in a planar form. Therefore, after the printing layer and the plastic article have been injection molded in a mold, patterns or words on the surface of the plastic article can only be presented in a planar form so that they are short of a three-dimensional feel and a sense of three-dimensional hierarchy.

In view of the above-mentioned circumstances, TW. Patent Publication No. I259987 disclosed an in-mold injection-molded three-dimensional label, in which a printing layer 10 is disposed on one surface of a raw material layer 1 and an adhesive material is then bonded on a portion of the surface of the printing layer 10 to form a three- dimensional portion 11 and thus highlight the effect of patterns or words in the three-dimensional portion 11. However, the three-dimensional portion 11 needs to be secondarily formed by bonding an adhesive material. This causes more trouble and inconvenience in processing and readily causes deformation of an injection-molded article.

### SUMMARY OF THE INVENTION

It is the primary object of the present invention to provide a three-dimensional print film structure, so as to solve the problem that it lacks a sense of three-dimensional hierarchy or the manufacturing procedure is complicated in the prior art.

To achieve the foregoing object, a three-dimensional print film structure according to the present invention comprises a film, a three-dimensional printing layer, a releasing layer, a pattern layer, an impact-resistant layer and a thermal tolerance bonding adhesive. The film has a first surface and a second surface. The three-dimensional printing layer is disposed on the first surface. The releasing layer is disposed on the second surface. The pattern layer is disposed on one side of the releasing layer. The impact-resistant layer is disposed on one side of the pattern layer. The thermal tolerance bonding adhesive is disposed on one side of the impact-resistant layer.

The thickness of the film is from 25 μm to 100 μm.

The three-dimensional printing layer is made by mixing an epoxy resin substrate with an inorganic oxide.

The inorganic oxide is one of a metal oxide and glass powder.

The mixing ratio of the epoxy resin substrate to the inorganic oxide is 10:7.

The three-dimensional printing layer is made by a screen printing method.

The thickness of the releasing layer is from 3 μm to 5 μm.

The releasing layer is made of a silicon gel.

The impact-resistant layer is made of organic ink.

### BRIEF DESCRIPTION OF THE DRAWINGS

FIG. 1 is a view of an in-mold injection-molded three-dimensional label according to the prior art.

FIG. 2 is a three-dimensional view of an embodiment of a three-dimensional print film structure according to the present invention.

FIG. 3 is a schematic structural view of an embodiment of a three-dimensional print film structure according to the present invention.

FIG. 4 is a schematic view of an embodiment of a three-dimensional print film structure according to the present invention before the mold is closed.

FIG. 5 is a schematic view of an embodiment of a three-dimensional print film structure according to the present invention after the mold is closed. FIG. 6 is a schematic view of an embodiment of a three-dimensional print film structure according to the present invention after the molded article is released from the mold.

FIG. 7 is a schematic view of a final product made using an embodiment of a three-dimensional print film structure according to the present invention.

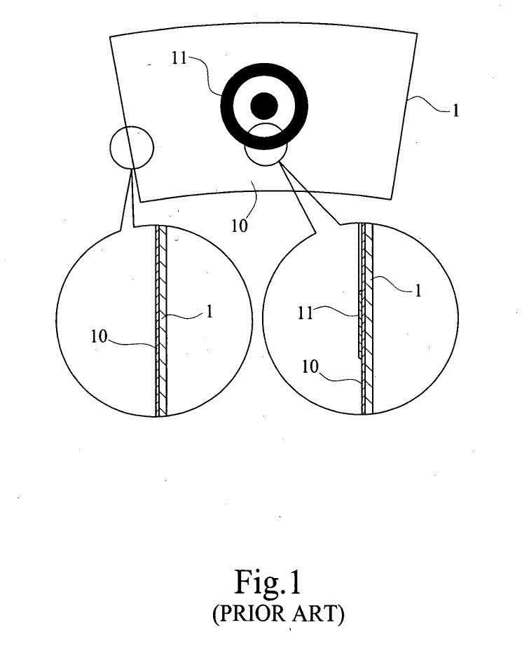

### DETAILED DESCRIPTION OF THE PREFERRED EMBODIMENTS

The contents of the present invention will become more apparent from the following description when taken in conjunction with the drawings.

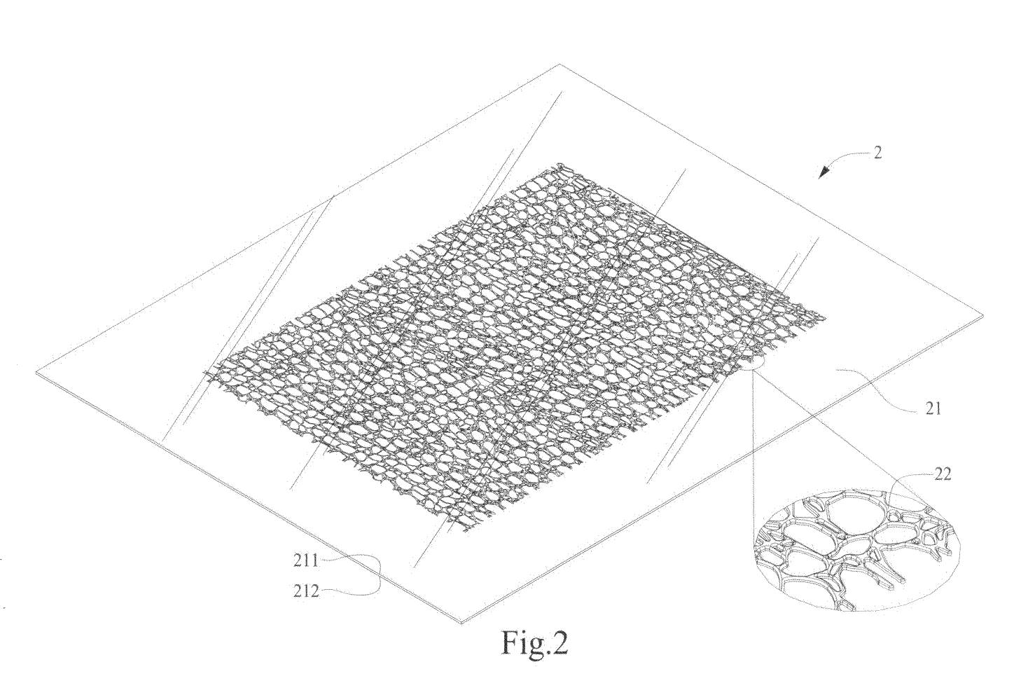

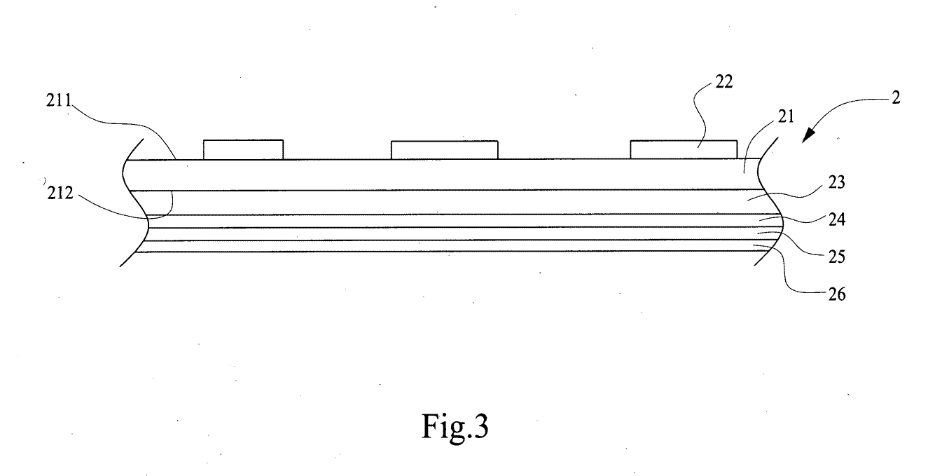

Referring to FIGS. 2 and 3, there are illustrated a schematic three-dimensional view and a schematic structural view of a three-dimensional print film structure according to the present invention. In these figures, the three-dimensional print film structure 2 comprises a film 21, a three-dimensional printing layer 22, a releasing layer 23, a pattern layer 24, an impact-resistant layer 25 and a thermal tolerance bonding adhesive 26.

The film 21 has a first surface 211 and a second surface 212 opposing to the first surface 211. In this embodiment, the film 21 may be made of a flexible plastic material, such as polyethylene terephthalate (PET), which belongs to linear saturated polyester resins, or other plastic materials. The thickness of the film may be between 25 μm and 100 μm, but the present invention is not limited thereto.

The three-dimensional printing layer 22 can be disposed on the first surface 211 by a screen printing method (using a 156T/in² silk screen with an ink layer having a thickness of more than 70 μm). The three-dimensional printing layer 22 may be made by mixing an epoxy resin substrate with an inorganic oxide and has a certain thickness. In this embodiment, the three-dimensional printing layer 22 may be formulated of 100 parts of the epoxy resin substrate and 70 parts of the inorganic oxide, that is, the mixing ratio of the epoxy resin substrate to the inorganic oxide may be 10:7. The composition is cured into a hard film with a thickness of more than 70 μm, but the present invention is not limited thereto. Furthermore, the inorganic oxide may be one of a metal oxide and glass powder, but the present invention is not limited thereto. The three-dimensional printing layer 22 may be formed as desired with various patterns, for example, scenes, figures, or mosaic patterns.

The releasing layer 23 can be disposed on the second surface 212. The thickness of the releasing layer may be from 3 μm to 5 μm, and it may be made of a silicon gel by screen printing using a 420S/in² silk screen. The pattern layer 24 may be printed as desired with various patterns and may be disposed on one side of the releasing layer 23. The impact-resistant layer 25 is made by screen printing with a 305S/in² silk screen having a thickness of about 15 μm so that the impact-resistant layer 25 can be disposed on one side of the pattern layer 24 to improve the impact resistance of a final product. The impact-resistant layer 25 may be made of organic ink, but the present invention is not limited thereto. After the impact -resistant layer 25 has been coated, the thermal tolerance bonding adhesive 26 can be further disposed on one side of the impact-resistant layer 25 so as to improve the thermal tolerance of the three-dimensional print film structure 2.

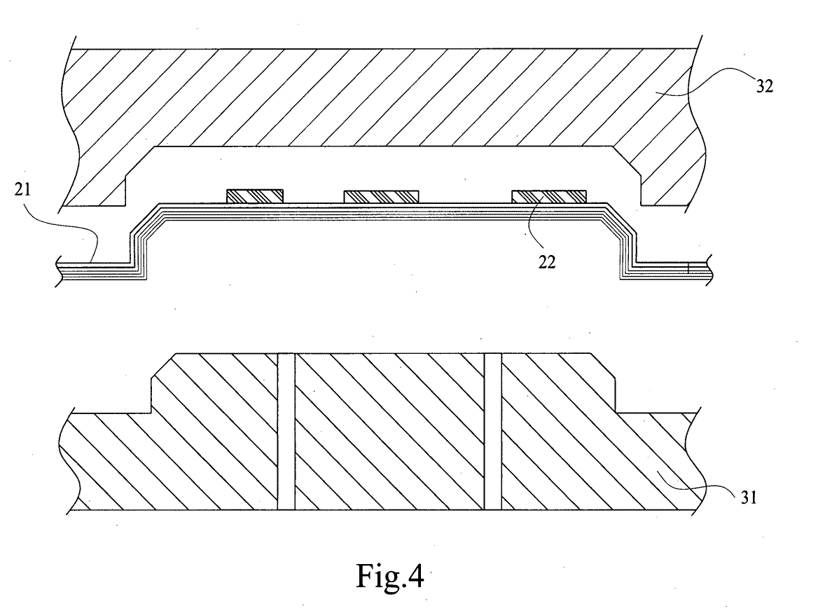

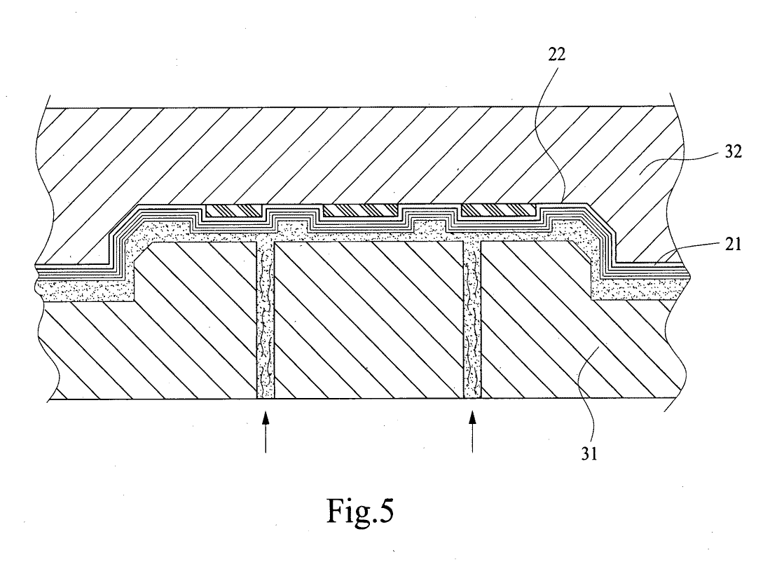

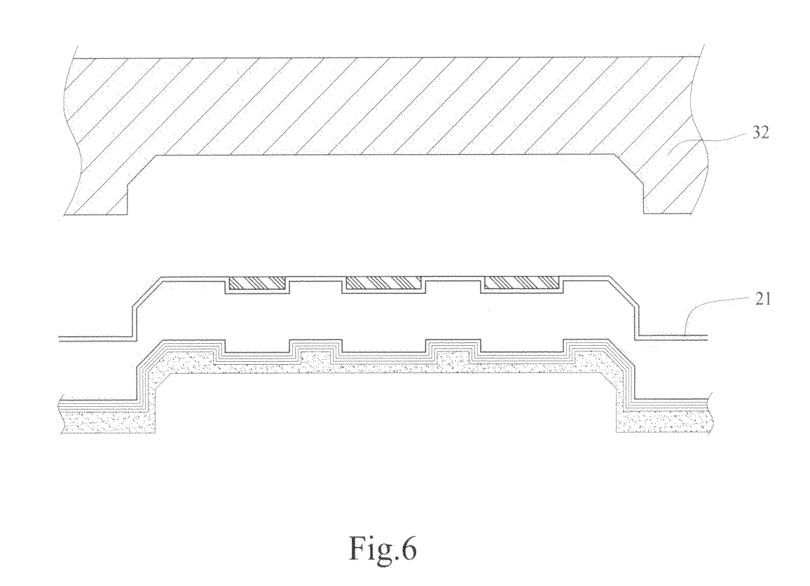

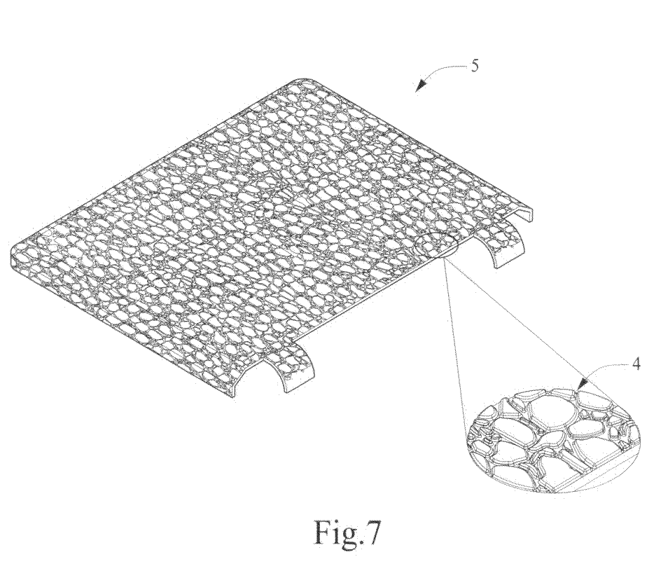

Referring to FIGS. 4, 5 and 6, there are respectively illustrated schematic views of an embodiment of a three-dimensional print film structure according to the present invention before the mold is closed, after the mold is closed and after the molded article is released from the mold. When the three-dimensional print film structure 2 is applied to in-mold injection-molded decoration, the three-dimensional print film structure 2 can be disposed in a mold having a male mold 31 and a female mold 32 such that the first surface 211 of the film 21 faces toward the female mold 32 and the second surface 212 faces toward the male mold 31. Next, an molten plastic material is injected at an injection temperature of about 220° to 300° C. and at an injection pressure of greater than about 80 kg/cm² into the mold such that the molten plastic material is injected between the three-dimensional print film structure 2 and the male mold 31. After that, the male mold 31 and the female mold 32 are closed. At the same time, the three-dimensional printing layer 22 is impacted and compressed by the female mold 32 to be reversely pressed into the plastic material so that a three-dimensional pattern layer 4 is formed on the plastic material, as shown in FIG. 7. Then, when the plastic material is released from the mold after cooled and solidified the film 21 and the three-dimensional printing layer 22 can be completely separated from the cooled and solidified plastic material with the aid of the releasing layer 23. The pattern layer 24, impact-resistant layer 25 and thermal tolerance bonding adhesive 26 completely remain on the surface of the cooled and solidified plastic material to form a final product 5. In this embodiment, the final product 5 may be an external case of an electronic device, but the present invention is not limited thereto. It may also be an external part of any article.

In summarization of the foregoing description, the effect of the three-dimensional print film structure according to the present invention is that a final product can be formed with a three-dimensional pattern by impressing the three-dimensional printing layer on a plastic material so as to provide an aesthetic effect of three-dimensional hierarchy and have a special three-dimensional feel over a final product made according to the prior art.

Another effect of the three-dimensional print film structure according to the present invention is that a three-dimensional pattern can be directly formed via the three-dimensional printing layer without disposing a printing layer on a raw material layer followed by bonding a plastic material on a surface of the printing layer to form a three-dimensional portion in the prior art, so that the processing time can be reduced.

What are described above are only preferred embodiments of the invention and should not be used to limit the scope of the present invention, and therefore all equivalent changes and modifications which do not depart from the spirit and scope of the present invention should be included in the appended claims.

In summarization of the foregoing description, the three-dimensional print film structure according to the present invention meets the requirements of inventiveness and industrial applicability of patents, and the application for an invention patent is duly filed accordingly.

What is claimed is:

1. A three-dimensional print film structure applicable to in-mold injection-molded decoration, comprising:
a film having a first surface and a second surface;
a three-dimensional printing layer disposed on the first surface;
a releasing layer disposed on the second surface;
a pattern layer disposed on one side of the releasing layer;
an impact-resistant layer disposed on one side of the pattern layer; and
a thermal tolerance bonding adhesive disposed on one side of the impact-resistant layer.

2. The three-dimensional print film structure as recited in claim 1, wherein the thickness of said film is from 25 μm to 100 μm.

3. The three-dimensional print film structure as recited in claim 1, wherein said three-dimensional printing layer is made by mixing an epoxy resin substrate with an inorganic oxide.

4. The three-dimensional print film structure as recited in claim 3, wherein said inorganic oxide is one of a metal oxide and glass powder.

5. The three-dimensional print film structure as recited in claim 3, wherein the mixing ratio of said epoxy resin substrate to said inorganic oxide is 10:7.

6. The three-dimensional print film structure as recited in claim 1, wherein said three-dimensional printing layer is made by a screen printing method.

7. The three-dimensional print film structure as recited in claim 1, wherein the thickness of said releasing layer is from 3 μm to 5 μm.

8. The three-dimensional print film structure as recited in claim 1, wherein said releasing layer is made of a silicon gel.

9. The three-dimensional print film structure as recited in claim 1, wherein said impact-resistant layer is made of organic ink.
